(19) United States
(12) Patent Application Publication
(10) Pub. No.: US 2010/0037227 A1
(43) Pub. Date: Feb. 11, 2010

(54) METHOD FOR DIGITAL PHOTO FRAME TASK SCHEDULE

(75) Inventors: YONG-HUI XIAO, Shenzhen City (CN); JIAN-FENG GUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/208,070

(22) Filed: Sep. 10, 2008

(30) Foreign Application Priority Data
Aug. 11, 2008 (CN) 200810303650.8

(51) Int. Cl. G06F 9/46

(52) U.S. Cl. 718/102

(57) ABSTRACT

A method for executing a task schedule on a DPF is disclosed. The method includes loading a task configuration file comprising at least one task capable of being executed at any given time, reading a current time from a clock within the DPF, checking if there is the task waiting to be executed, executing the task if there exists the task waiting to be run, and repeating the reading a current time step, after a wait time, if no tasks have been scheduled for current execution.

### BACKGROUND

1. Technical Field

The present invention relates to a method for digital photo frame task scheduling.

2. Description of Related Art

Digital photo frames have become increasingly popular. They have many functions, such as displaying photos, playing songs, and playing network broadcasts, etc. However, users must operate the digital photo frame each time they want to use one of the functions or change to another function. For example, a user may regularly listen to a 7:00 broadcast each morning and listen to songs at 10:00 each evening on their digital photo frame. Thus, the user must manually operate the digital photo frame each time. This is very inconvenient.

Therefore, there is room for improvement within the art.

### BRIEF DESCRIPTION OF THE DRAWINGS

FIG. 1 is a DPF of an embodiment of a method for DPF task scheduling;

FIG. 2 is a block diagram of an embodiment of the method for scheduling DPF tasks;

FIG. 3 is a flow chart of an embodiment of the method for scheduling DPF tasks;

FIG. 4 is a flow chart of an embodiment of the method for modifying scheduled DPF tasks;

FIG. 5 is a flow chart of an embodiment of the method for canceling scheduled DPF tasks; and

FIG. 6 is a flow chart of an embodiment of the method for executing scheduled DPF tasks.

### DETAILED DESCRIPTION OF THE EMBODIMENTS

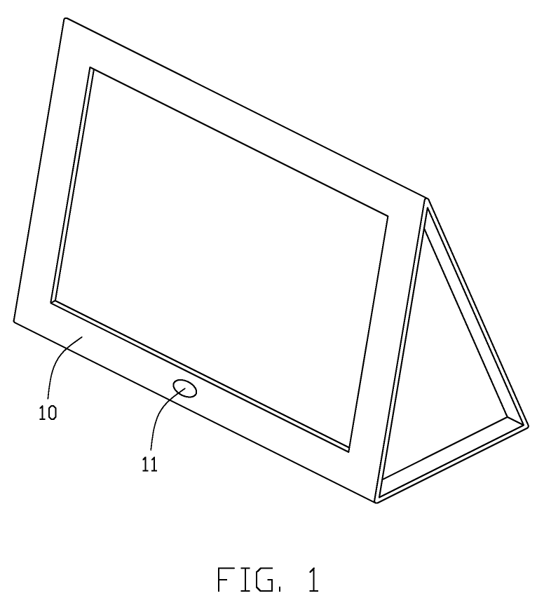

Referring to FIG. 1, a digital photo frame (DPF) 10 is used to complete a method for a scheduled tasks associated with operation of the DPF. A menu button 11 associated with the DPF 10 allows function selection.

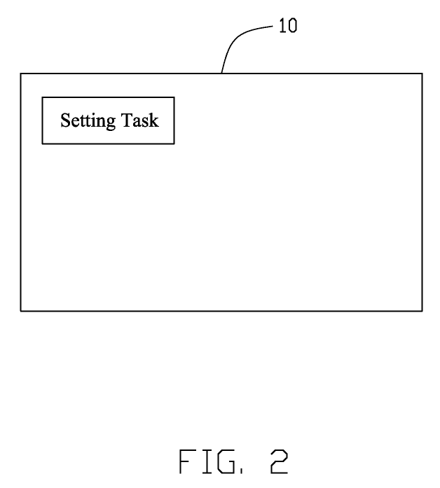

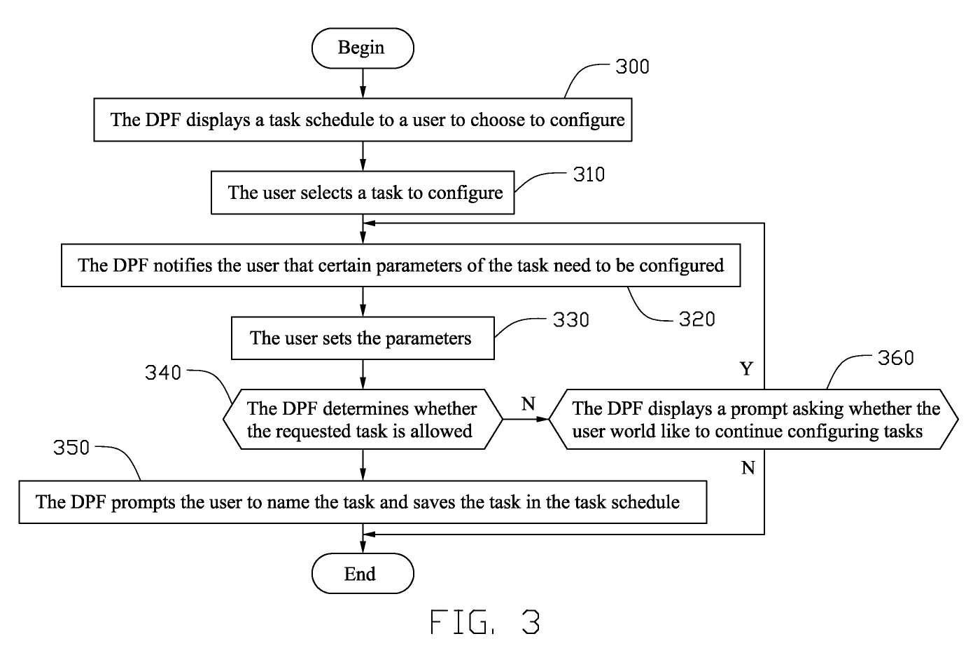

Referring to FIGS. 2 and 3, when pressing the menu button 11, a Setting Task function is shown to a user on the DPF 10. After selecting the Setting Task function, the DPF 10 sets tasks according to the steps below. Depending on the embodiment, certain steps described below may be removed, while others may be added, and the sequence of steps may be altered as well.
Step 300: the DPF 10 displays a task schedule for the user to configure, for example, listening to songs or listening to broadcasts.
Step 310: the user selects a task to configure from the task schedule.
Step 320: the DPF 10 notifies the user that certain parameters of the task need to be configured according to Step 310, for example, when listening to a broadcast, the starting time, ending time, and channel need to be predetermined.
Step 330: the user sets the parameters according to the notifications from the DPF 10.
Step 340: the DPF 10 determines whether the requested task is allowed, for example, the user is not allowed to simultaneously set two tasks that take place at the same time or share resources, such as listening to both songs and broadcasts at the same time. If the task is allowed, proceed to Step 350; if the task is not allowed, skip to Step 360.
Step 350: the DPF 10 prompts the user to name the task, and saves the task in the task schedule.
Step 360: the DPF 10 displays a prompt asking whether the user would like to continue configuring tasks. If the user chooses to continue, proceed to Step 320; if not, the process is over.

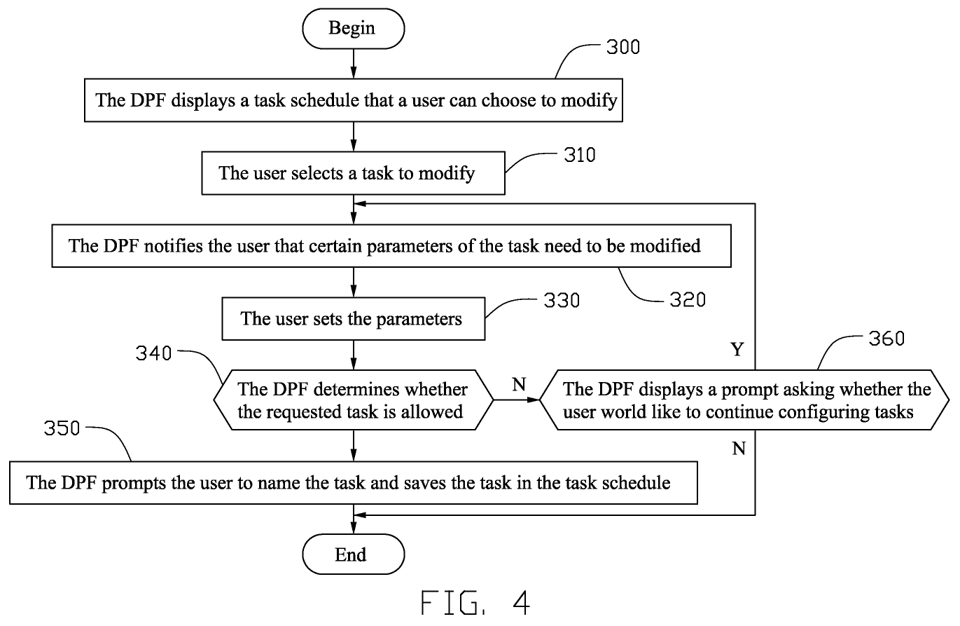

Referring to FIG. 4, a flowchart for modifying tasks is shown.
Step 400: the user can use the menu button 11 to select the Modifying Task function (not shown). The DPF 10 displays a task schedule that the user can choose to modify. The user can modify tasks that have been previously configured, such as listening to songs or listening to a broadcast.
Step 410: the user selects a task from the task schedule to modify.
Step 420: the DPF 10 notifies the user of task parameters that need to be modified according to Step 410, for example, when listening to broadcast, the starting time, ending time, and channel need to be predetermined.
Step 430: the user modifies the parameters according to the notification from the DPF 10.
Step 440: the DPF 10 determines whether the requested task is allowed for reasons similar to those described above concerning step 340. If the task is allowed, proceed to Step 450; if the task is not allowed, skip to Step 460.
Step 450: the DPF 10 prompts the user to name the task, and saves the task in the task schedule.
Step 460: the DPF 10 displays a prompt asking whether the user would like to continue configuring tasks. If the user chooses to continue, proceed to Step 420; if not, the process is over.

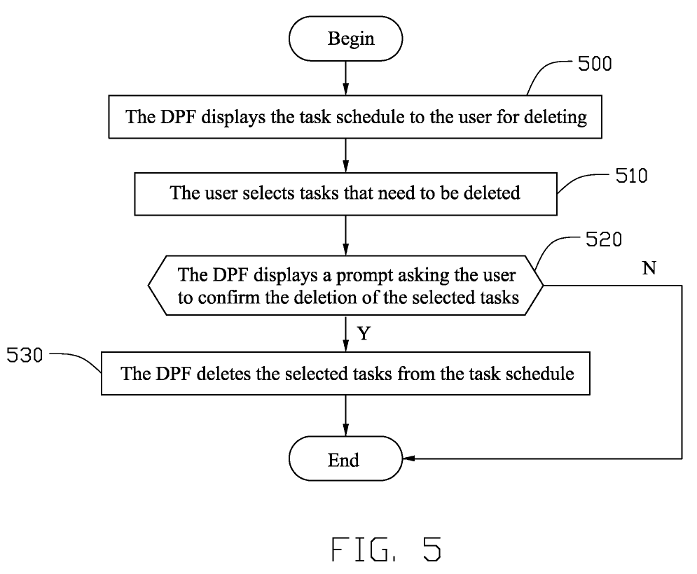

Referring to FIG. 5, a flowchart for deleting tasks is shown.
Step 500: the user can use the menu button 11 for deleting tasks. The DPF 10 displays the task schedule to the user for deleting.
Step 510: the user selects the tasks that need to be deleted.
Step 520: the DPF 10 displays a prompt asking the user to confirm the deletion of the selected tasks. If the user confirms the deletion, proceed to Step 530; if not, the process is over.
Step 530: the DPF 10 deletes the selected tasks from the task schedule.

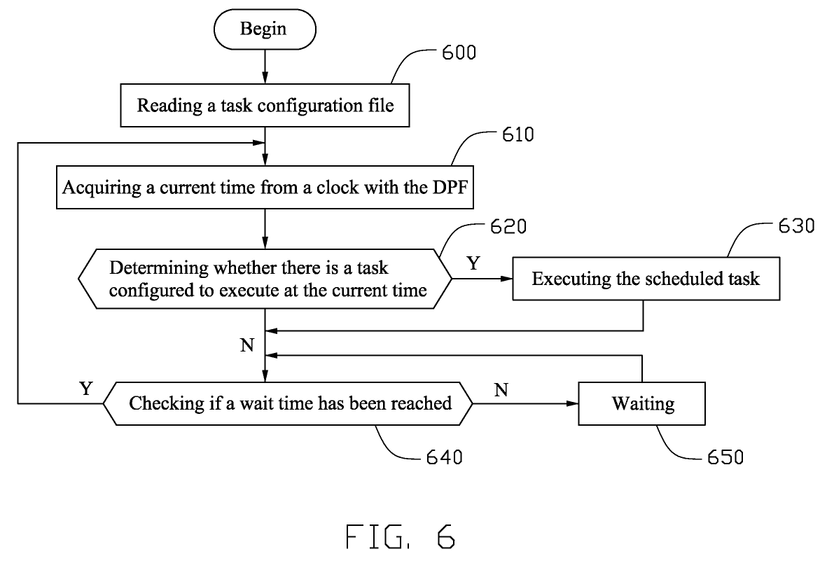

Referring to FIG. 6, a flowchart of the method for completing tasks in the task schedule is shown.
Step 600: when the user starts the task schedule, the method reads a task configuration file therein.
Step 610: the method acquires the current time according to a clock within the DPF 10.
Step 620: the method determines whether there is a task configured to execute at the current time. If so, proceed to Step 630; if not, skip to Step 640.
Step 630: the method executes the scheduled task.
Step 640: the DPF 10 checks if a wait time (for example, 1 minute) has been reached. If so, return to Step 610; if not, proceed to Step 650.
Step 650: the method is waiting. When the wait time has been reached, return to Step 640.

Thus, if the user wants to listen to a broadcast at 7:00 in the morning, the user can schedule this task on the DPF 10. Subsequently, the DPF 10 will automatically play the requested broadcast at 7:00 in the morning.

It is to be understood, however, that even though numerous characteristics and advantages of the present embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A method for executing a task schedule on a DPF comprising:
loading a task configuration file comprising at least one task capable of being executed at any given time;
reading a current time from a clock within the DPF;
checking if there is the task waiting to be executed;
executing the task if there exists the task waiting to be run; and
repeating the reading a current time step, after a wait time, if no tasks have been scheduled for current execution.

2. The method of claim 1, wherein the wait time is one minute.

3. The method of claim 1, further comprising setting task parameters for additional tasks to be executed on the DPF.

4. The method of claim 3, wherein two tasks to be carried out at the same time are not allowed to be scheduled.

5. The method of claim 1, further comprising modifying task parameters for a task on the DPF.

6. The method of claim 5, wherein two tasks to be carried out at the same time are not allowed to be scheduled.

7. The method of claim 1, further comprising deleting a task from the task configuration file when no longer needed.
